(19) United States
(12) Patent Application Publication
(10) Pub. No.: US 2012/0204036 A1
(43) Pub. Date: Aug. 9, 2012

(54) Encryption Scheme

(75) Inventors: C. Jay Wack, Herndon, VA (US); James L. Kolouch, Herndon, VA (US)

(73) Assignee: TECSEC, Herndon, VA (US)

(21) Appl. No.: 13/189,362

(22) Filed: Jul. 22, 2011

Related U.S. Application Data
(63) Continuation-in-part of application No. 10/194,742, filed on Jul. 12, 2002.
Application No. 10/194,742 is a continuation of application No. 09/421,293, filed on Oct. 20, 1999, now Pat. No. 6,694,433.
Application No. 09/421,293 is a continuation-in-part of application No. 09/074,649, filed on May 8, 1998, now abandoned.
(60) Provisional application No. 61/366,663, filed on Jul. 22, 2010.
(60) Provisional application No. 60/045,935, filed on May 8, 1997.

(51) Int. Cl. G06F 21/24; G06F 17/00

(52) U.S. Cl. 713/189

(57) ABSTRACT

Cryptographically converting raw data into a structured electronic document can include parsing the raw data to identify at least one raw data object. A target data object is selected from the raw data object(s). For each selected target data object, the target data object is encrypted according to a cryptographic scheme to create an encrypted data object. Each selected target data object is replaced with the respective encrypted data object, and is associated with markup data in a structured format for each respective encrypted data object, resulting in the structured electronic document. The format of the structured electronic document can be compliant with a formatting language, which can be a general-purpose or specific-purpose formatting language.

### PRIORITY CLAIM AND CROSS-REFERENCE TO RELATED DOCUMENTS

This document claims the priority, and incorporates by reference in its entirety, U.S. Provisional Application for Patent Ser. No. 61/366,663, filed on Jul. 22, 2010. This document is also a continuation-in-part of co-pending U.S. patent application Ser. No. 10/194,742, filed on Jul. 12, 2002, which in turn is a continuation of U.S. patent application Ser. No. 09/421,293, filed on Oct. 20, 1999, now U.S. Pat. No. 6,694,433, issued on Feb. 17, 2004, which in turn was a continuation-in-part of U.S. patent application Ser. No. 09/074,649, filed on May 8, 1998, now abandoned, which in turn claimed priority under 35 U.S.C. §119 of U.S. Provisional Application for Patent Ser. No. 60/045,935, filed on May 8, 1997.

### FIELD OF THE INVENTION

Cryptographic systems are often used to prevent unauthorized disclosure of information during transmission and/or storage of data. The process of encryption involves the manipulation of data so that it is unreadable, in effect making the content inaccessible, to an unauthorized entity. The process of decryption involves the manipulation of encrypted data so as to recreate the original scheduled condition of the data, or to transform the encrypted data into readable data that corresponds to the original unencrypted data. Secrecy is not the only advantage provided by encryption. The process of encryption ensures data integrity, as encrypted data that has been modified does not decrypt properly unless the proper, that is, authorized, procedures are followed.

### BACKGROUND OF THE INVENTION

The corporate world used to depend solely on paper to operate. Hard-copy documents were used to provide corporate governance, settle disputes at law, and formed the basis for audits by tax and regulatory authorities, internal authorized recipients, and independent accountants. In many instances, this is no longer the case. As business moves to electronic operational and accounting systems, hard-copy documents in many cases either do not exist or are merely incidental to electronic records. This lack of hard copy affects the ability of management and other interested parties to manage and audit corporate systems.

An original paper document carries a degree of presumption of authenticity that cannot currently be attributed to an electronic file. Changes can be virtually impossible to detect in the electronic world. With electronic data interchange, a company uses computers, computer programs, and transmission links to transact business automatically with customers and suppliers. With image processing systems, documents are scanned and converted to digital images. The original documents might not be retained. Some electronic information might exist for only a short time and might not be retrievable if files are updated and backup files do not exist.

A company can have many information and control systems. In this context, a system is the entire combination, or a logical sub-part, of tangible and intangible elements that, acting together, protect assets and provide reliable data, or the assurance thereof. The tangible part of the system includes, but is not limited to, paper documents and the markings and signatures made thereon, as well as the physical processes and procedures used to safeguard assets. System intangibles include policies and procedures providing instructions and structure to the business process.

Management and other interested parties must determine that policies, procedures, and instructions are carried out to a sufficient degree in a timely fashion. Information and control systems provide this assurance. Authorized recipients review information and control systems to determine if the design of each meets stated objectives. They also review the synergistic effect of all relevant systems to determine their overall effectiveness. If the sum of all system designs is deemed to be effective in producing stated objectives, authorized recipients then must perform tests of these systems in order to prove the systems actually exist and are functioning as represented by management.

Based on the volume of information involved, authorized recipients and others reviewing corporate activities cannot directly examine all activities and data produced by a company. They must devise tests for evaluating the activities and data that they can directly examine, in order to provide a reliable indication of the overall well-being of the corporation. The nature, timing, and extent of these tests are based on professional judgment. Tests include those steps necessary to verify that stated control elements exist and are functioning as intended. Tests also include the examination of particular transactions to provide operational assurance on a statistical basis.

The tests of both controls and transactions can include the examination of documents produced both within the company and by outside entities. For some audit objectives, such as confirmation of balances, activities, agreements, etc., evidence will be obtained from parties independent of the company. The authorized recipient's goal is to reduce to an acceptable level the risk of not discovering a material misstatement or system control deficiency. If an authorized recipient cannot reduce detection risk to an acceptable level, it might be impossible to render an unqualified opinion.

As more businesses adopt electronic systems and interact electronically with vendors, and customers, the ability to reliably audit both controls and transactions is greatly diminished, perhaps, in some cases, to the point that serious adverse control and audit consequences will become common.

### SUMMARY OF THE INVENTION

An objective of the present invention is to use encryption and encrypted objects to record and authenticate inputs, processes, scheduled conditions, and virtual environments of electronic accounting and operational systems, and to provide a means to distribute these encrypted objects to designated locations for access by designated individuals or entities.

Inputs in this context can be any individual action or sum of actions having any effect on a control or accounting system. Outputs in this context can be the result of any process or action of a control or accounting system. These actions can be transactional in nature, directly entered by a human being as the first electronically recorded action, or can be a result of computations within the system, or can be passed to the system by another system.

According to an exemplary aspect of the invention, a method of cryptographically converting raw data into a structured electronic document includes parsing the raw data to identify at least one raw data object. At least one target data object is selected from the at least one raw data object. For each selected target data object, the target data object is encrypted according to a cryptographic scheme to create an encrypted data object. Each selected target data object is replaced with the respective encrypted data object, and is associated with markup data in a structured format for each respective encrypted data object, resulting in the structured electronic document. The format of the structured electronic document complies with a formatting language.

The format of the structured electronic document can comply, for example, with a Hypertext Markup Language and a scripting language.

The scripting language can be, for example, Javascript, Jscript, ECMAScript, or C.

The format of the structured electronic document can also comply, for example, with a Document Object Model or a Cascading Style Sheet.

The formatting language can be, for example, a general-purpose markup language. For example, the formatting language can be an eXtensible Markup Language, a Standard Generalized Markup Language, a HyperText Markup Language, a Dynamic HyperText Markup Language, an eXtensible HyperText Markup Language, or a Serialization of a Resource Description Framework.

The formatting language can be a specific-purpose markup language.

The formatting language can be one that is adapted for a use relating to a financial industry. For example, the formatting language can be a Financial Products Markup Language.

The formatting language can be one that is adapted for a use relating to documents. For example, the formatting language can be a LaTeX markup language.

The formatting language can be one that is adapted for a use relating to business. For example, the formatting language can be a Business Narrative Markup Language, a Business Process Modeling Language, or an eXtensible Business Reporting Language.

The formatting language can be one that is adapted for a use relating to at least one of military and law enforcement. For example, the formatting language can be a Bullet Markup Language.

The formatting language can be one that is adapted for a use relating to a human manifestation and/or a human perception. For example, the formatting language can be an Emotion Markup Language, a Virtual Human Markup Language, an Artificial Intelligence Markup Language, a Dialogue Manager Markup Language, a Dialogue Moves Markup Language, a Facial Animation Markup Language, a Body Animation Markup Language, a Speech Markup Language, a Voice Markup Language, and Extensible Messaging and Presence Protocol, an Ink Markup Language, a Virtual Reality Markup Language, or an X3d.

The formatting language can be one that is adapted for a use relating to media. For example, the formatting language can be a Synchronized Multimedia Integration Language, a Meta Content Framework, a Browser Binary Markup Language, an eXtensible Bindings Language, or an XML Bookmark Exchange Language.

The formatting language can be one that is adapted for a use relating to aerospace. For example, the formatting language can be an Aerospace Markup Language or a Parameter Value Language.

The formatting language can be one that is adapted for a use relating to research. For example, the formatting language can be a Systems Biology Markup Language.

The markup data can describe, at least in part, the structure of the electronic document.

The markup data can describe, at least in part, an attribute of at least one encrypted data object.

The markup data can include at least one tag.

The raw data can include virtual data.

The raw data can include actual data.

The one or more selected target objects can include a database command, a conditional operator, a function, and/or a network application production element.

The one or more encrypted data objects can include a database command, a conditional operator, a function, and/or a network application production element.

The one or more selected target objects can represent, at least in part, a product of a foreign exchange swap, a foreign exchange option, an interest rate swap, an inflation swap, an asset swaps, a swaption, a credit default swap, a credit default swap index, a credit default swap basket, a tranch on credit default swap index, an equity option, an equity swap, and/or a total return swap.

The one or more encrypted data objects can represent, at least in part, a product of a foreign exchange swap, a foreign exchange option, an interest rate swap, an inflation swap, an asset swaps, a swaption, a credit default swap, a credit default swap index, a credit default swap basket, a tranch on a credit default swap index, an equity option, an equity swap, and/or a total return swap.

The one or more selected target objects can involve a process of trading, valuation, confirmation, novation, increase, amendment, termination, allocation, position reporting, cash flow matching, defining a party role, and/or trade notification.

The one or more encrypted data objects can involve at least one process of trading, valuation, confirmation, novation, increase, amendment, termination, allocation, position reporting, cash flow matching, defining a party role, or trade notification.

The one or more selected target objects can represent, at least in part, an electronic ink image.

The one or more encrypted data objects can represent, at least in part, an electronic ink image.

The one or more selected target objects can represent, at least in part, metadata.

The one or more encrypted data objects can represent, at least in part, metadata.

The one or more selected target objects can include compressed Web page data.

The one or more encrypted data objects can include compressed Web page data.

The one or more selected target objects can represent, at least in part, an entry in a Planetary Database System.

The one or more encrypted data objects can represent, at least in part, an entry in a Planetary Database System.

The one or more selected target objects can represent, at least in part, a Uniform Resource Identifier.

The one or more encrypted data objects can represent, at least in part, a Uniform Resource Identifier.

The one or more selected target objects can involve, at least in part, timing, layout, animation, visual transition, and/or media embedding of a media presentation.

The one or more encrypted data objects can involve, at least in part, timing, layout, animation, visual transition, and/or media embedding of a media presentation.

According to another aspect of the invention, at least one object relating to a process is provided, consistent with a data format. A first object having an object tag associated therewith is selected. For example, the first object can be an Extensible Markup Language element or any other markup language element or any tagged data element. At least a portion of the first object is encrypting according to at least one cryptographic scheme determined at least in part by the object tag. The encrypted at least a portion of the first object is stored for subsequent use by an intended recipient.

According to another aspect of the invention, at least one object relating to a process is provided, consistent with a data format. For example, the data format can be an Extensible Markup Language format or any other markup language format or any tagged data element format. A first object having an object tag associated therewith is selected. At least a portion of the first object is encrypted according to at least one cryptographic scheme determined at least in part by the object tag. The encrypted at least a portion of the first object is stored for subsequent use by an intended recipient.

According to another aspect of the invention, at least one object relating to a process is provided, consistent with a data format. A first object is selected having an object tag associated therewith. For example, the object tag can be an Extensible Markup Language tag or any other markup language tag or any data element tag. At least a portion of the first object is encrypted according to at least one cryptographic scheme determined at least in part by the object tag. The encrypted at least a portion of the first object and the object tag are stored for subsequent use by an intended recipient.

According to another aspect of the invention, an article of manufacture including a program storage medium tangibly embodying one or more programs of instructions executable by a computer to perform a process encompassing any of the aspects of the invention described above.

According to another aspect of the invention, a first computer readable medium is provided having stored thereon a first data set including a first object and an object tag associated therewith. At least a portion of the first object is encrypted according to at least one cryptographic scheme determined at least in part by the object tag. A second data set creating including the encrypted at least a portion of the first object. The second data set is stored on the first computer readable medium and/or a second computer readable medium. The first object can be, for example, an Extensible Markup Language element or any other markup language element or any tagged data element. The object tag can be, for example, an Extensible Markup Language tag or any other markup language tag or any data element tag. The data format can be, for example, an Extensible Markup Language data format or any other markup language data format or any tagged data format. The encrypted at least a portion of the first object can be formatted within the second data set according to the syntax or another syntax. The other syntax can be of another Extensible Markup Language or other markup language.

### BRIEF DESCRIPTION OF THE DRAWINGS

FIG. 1 is a flow diagram of a system using encryption as a tool for checking the integrity of a process;

FIG. 2 is a flow diagram showing encryption used in an output context;

FIG. 3 shows a process by which selected process elements provided as inputs to the process are manipulated;

FIG. 4 shows how scheduled conditions can be sampled in a system;

FIG. 5 shows virtual environmental data collected and embedded within an encrypted object;

FIG. 6 is a flow diagram showing use of XML to identify, copy, and encrypt input objects in a SAOCRS;

FIG. 7 is a flow diagram showing use of XML to identify, copy, and encrypt copied output objects in a SAOCRS;

FIG. 8 is a flow diagram showing use of XML to identify, copy, and encrypt copied objects in a SAOCRS that in their entirety present a scheduled condition check; and

FIG. 9 illustrates an exemplary method of the present invention in which raw data can be cryptographically converted into a structured electronic document that complies with a formatting language.

### DETAILED DESCRIPTION OF THE INVENTION

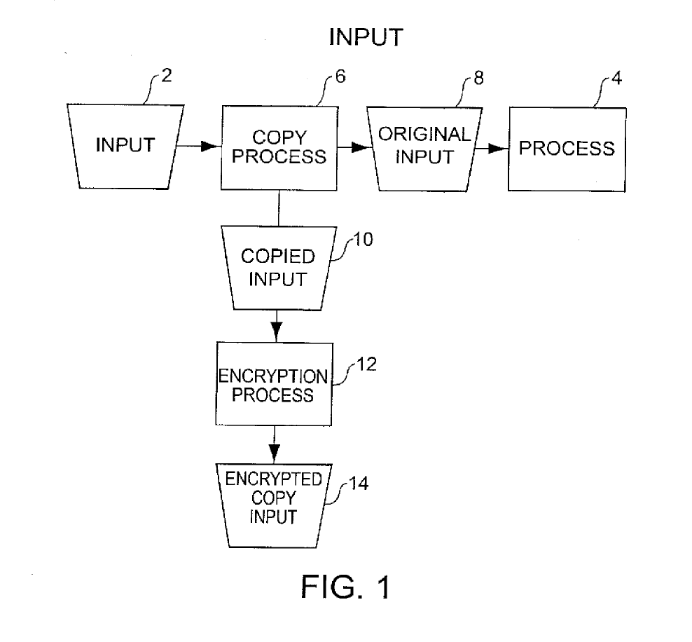

FIG. 1 is a flow diagram of a system using encryption as a tool for checking the integrity of a process. An input 2 is provided to a system, which is intended to be manipulated by a process 4. However, this input 2 first undergoes a copy process 6 to provide identical inputs 8 and 10. The input 8 is passed on to be processed 4, while the input 10 is encrypted by an encryption process 12. The result of the encryption process 12 is an encrypted copy input 14. An authorized recipient will consider this encrypted copy input 14 to be reliable, due to the integrity provided by the encryption process 12.

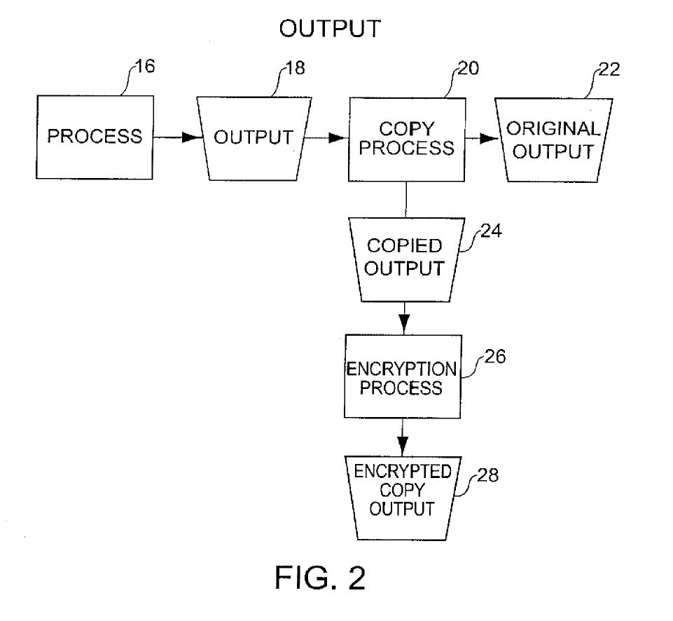

Similarly, FIG. 2 shows encryption used in an output context. A process 16 of the system produces an output 18. This output undergoes a copy process 20 to produce two identical outputs 22 and 24. The output 22 continues to its normal destination as determined by the functionality of the system. The output 24 is provided to an encryption process 26, which manipulates the output 24 to generate an encrypted copy output 28. An authorized recipient will consider this encrypted copy output 28 to be reliable, due to the integrity provided by the encryption process 26.

Processes in this context are the manipulation of data according to a set of defined

procedures in order to produce a desired result. The result of a process can be used as an input to another process, either within or outside the sub-system, or can be for use outside of the electronic system, such as for display on a screen or other presentation device for direct human use.

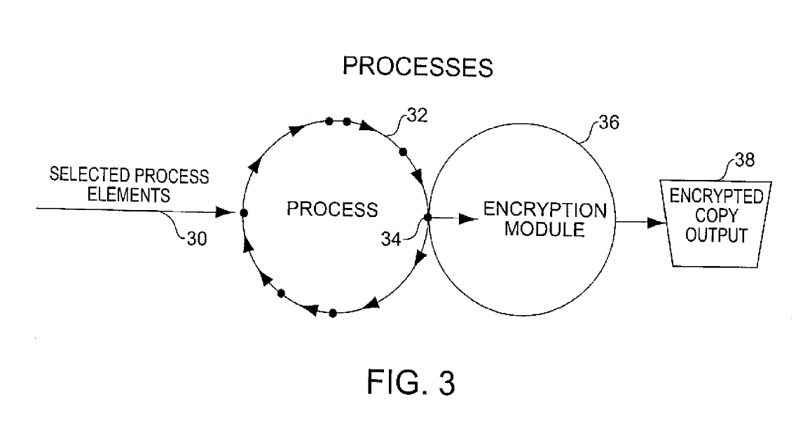

For example, FIG. 3 shows a process 32 by which selected process elements 30, provided as inputs to the process 32, are manipulated. At a predetermined point 34 in the process 32, the process 32 can be sampled and encrypted by the encryption module 36 to provide an encrypted output 38. Thus, an authorized recipient examining a decrypted version of the encrypted output 38 would have a high level of confidence in the reliability of the process sample due to the integrity provided by the encryption module 36.

Scheduled conditions in this context are the status of all or designated processes, registers, and other conditions within a system at specific times. A review of chronological records of this status information provides evidence of how the system functioned during a specific time period.

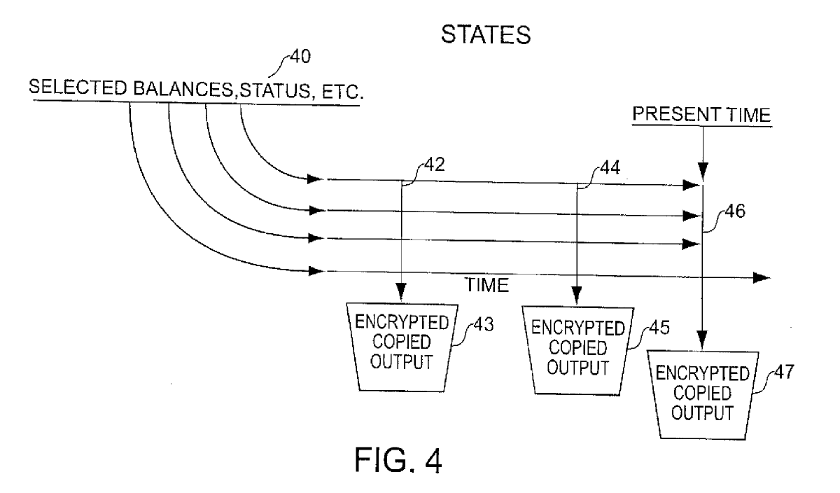

For example, FIG. 4 shows how scheduled conditions can be sampled in a system, so that they can be encrypted to provide a secure, reliable “snapshot” of the system at particular points in time. As the system operates, selected balances, status, and other processes are sampled at different points in time 42, 44, 46. As shown, at a first point in time 42, the processes 40 were sampled to provide a reading of the scheduled condition of the system at that point in time 42. This scheduled condition sample was then encrypted to provide a characteristic encrypted output 43 at the first selected point in time 42. Likewise, at a second point in time 44, the processes 40 were sampled to provide a reading of the scheduled condition of the system at that point in time 44. This scheduled condition sample was then encrypted to provide a second characteristic encrypted output 46 at the second selected point in time 44. Finally, at the present time 46, the processes 40 are sampled to provide a reading of the present scheduled condition of the system. This scheduled condition sample is then encrypted to provide a characteristic encrypted output 47 of the present scheduled condition of the system. Future samples can be taken and encrypted outputs generated. Thus, an authorized recipient examining a decrypted version of the encrypted outputs 43, 45, 47 would have a high level of confidence in the reliability of the scheduled condition samples due to the integrity provided by the encryption process.

Virtual environments in this context are the conditions and influences that were present in the system at the time of encryption. By including virtual environmental information in the scope of encryption, the nature and effect of all influences on encrypted objects can be recorded and analyzed. Virtual environmental information would include, but not be limited to, such things as the order of processing as compared to similar or other items; preprocessing of data, such as data conversion and reformatting; status of other active processes or threads; operating system control information; identity of users logged on; network monitoring information; and other active control processes.

By bonding virtual environmental information to selected data objects with encryption, not only is the integrity of the data object assured, but also the nature and extent of the environment that produced the object can be verified. Further, encrypted objects can be embedded within other objects, encrypted or otherwise, to provide an access hierarchy for users of a system, as described in U.S. Pat. No. 5,369,702 to Shanton. Encrypted objects within the context of the present invention provide verification of the electronic control hierarchy for management and other parties.

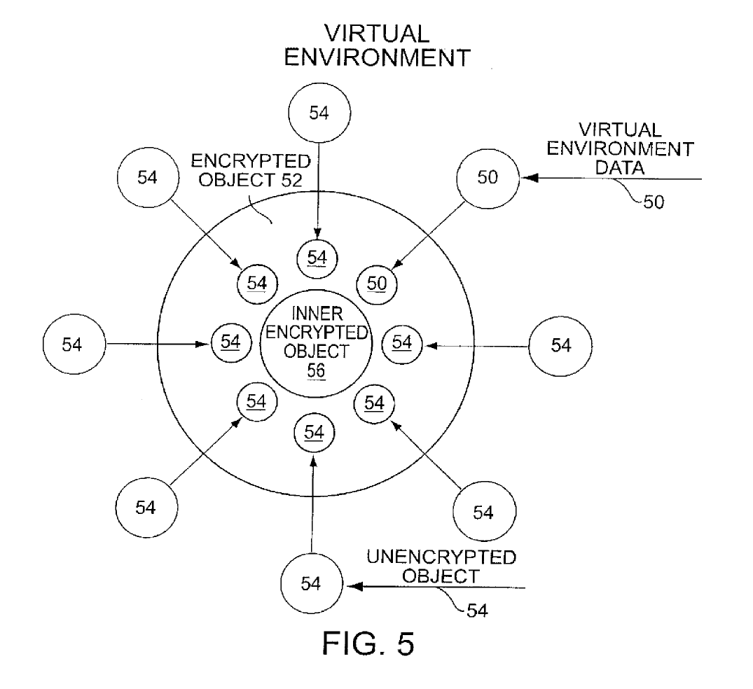

FIG. 5 shows how virtual environmental data 50 can be collected and embedded within an encrypted object 52. Other related unencrypted objects 54 can also be embedded within the same encrypted object 52, as can be another encrypted object 56. Of course, the collected virtual environment data 50 can be encrypted prior to being embedded within the encrypted object 52, and the inner encrypted object 56 can contain other encrypted and/or unencrypted objects. An authorized recipient examining an extracted virtual environment data object would have a high level of confidence in the reliability of the corresponding data due to the integrity provided by the encryption process used to create the container for the object.

Management, taxing jurisdictions, regulatory authorities, internal authorized recipients, independent accountants, and other parties, can use these features to monitor and audit control systems, as well as the interaction of control systems—a significant benefit as business moves to an electronic world. With this technology, control systems that allow for substantive procedures can provide evidence that other control systems are operating as designed.

Thus, the system can be viewed as an encryption process used to protect and control related objects, or it can be viewed as an audit and control tool to ensure the integrity of the process. A process, such as XML, extends management flow controllability over objects within or retrieved from databases.

The invention will now be described in terms of a particular process, that is, the Extensible Markup Language (XML), for ease of explanation. It is important to note, however, that the invention is not limited to use of this exemplary process, and is intended to be used as broadly as described elsewhere herein. XML is a method that is used to structure and describe data so that it can be understood by different software applications, including database and electronic commerce applications. XML uses tags to label data objects as to meaning, preferably using a specific common industry-wide convention, so that software applications with different purposes and created by different vendors can pass data objects between and among them without the need to restructure the data. XML allows applications to use tagged data objects for input.

XML can be used for information that is transferred from one application to another. Applications include, but are not limited to, business transactions, financial statements, purchase orders, product catalogs, medical histories, database retrieval, etc.

In this example, XML tags are used by application, and perhaps operating system, software to identify accounting and operational control system objects. Secure accounting and operational control and reporting system (SAOCRS) application software examines selected tagged data objects and, if appropriate, encrypts a copy of the tagged object or groups of objects. Further, encrypted objects can be embedded within other objects, encrypted or otherwise, to provide an access hierarchy for users of a system, as described in U.S. Pat. No. 5,369,702 to Shanton. XML labels can be directly related to or can be grouped or converted in order to relate to referenced process.

The encrypted objects are then either passed directly on a real-time basis to authorized recipients for immediate decryption and further processing, or they are stored and forwarded at a later time.

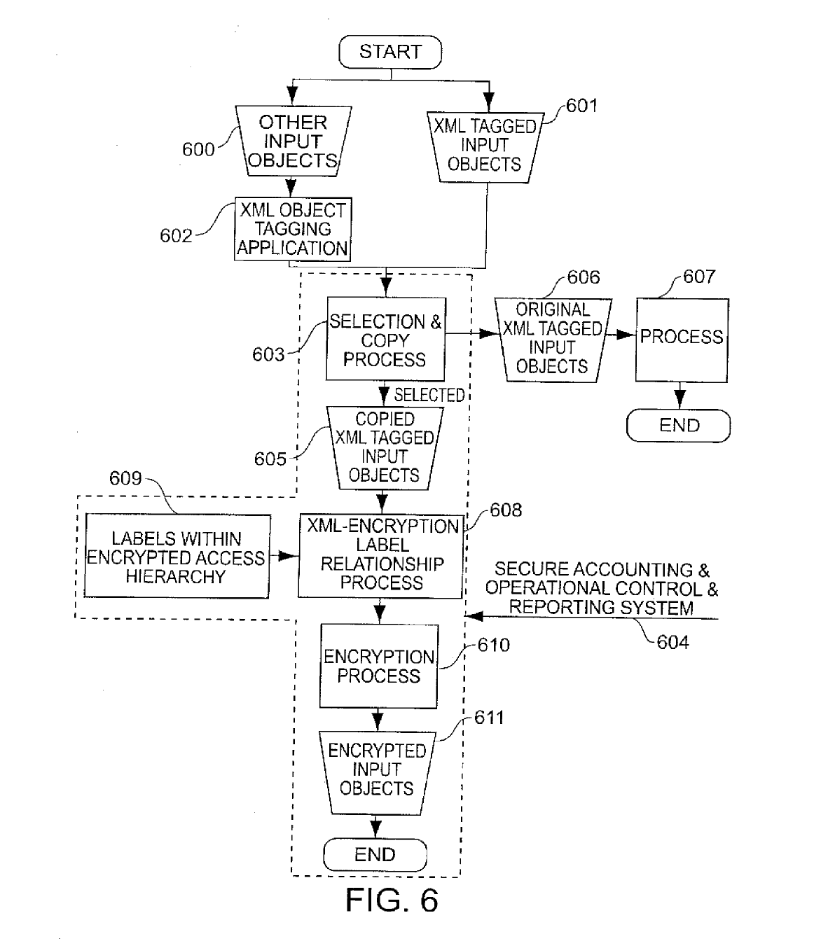

FIG. 6 is a flow diagram showing use of XML to identify, copy, and encrypt input objects in a SAOCRS. Initially, input objects 600 might or might not be related to XML tags; if so, the XML-tagged input objects 601 are provided directly to the selection and copy process 603. If required, an XML object-tagging application 602 applies appropriate XML tags to the input objects 600. The SAOCRS 604, using XML tags to identify object attributes, selects certain objects 605 according to control requirements and causes identical copies to be made. Original tagged input objects 606 are allowed to pass to their intended processes 607.

Within the SAOCRS 604, the XML tags of each copy of selected input objects 605 are related 608 to labels within the encrypted access hierarchy 609 to determine the appropriate role-based access label or labels to be used to encrypt each object. Role-based labels are descriptors of a type or category of access, rather than the identity of a particular person or device allowed access. Each input object copy is encrypted 610 and passed to or stored 611 for appropriate persons, devices, or other systems, including other SAOCRSs.

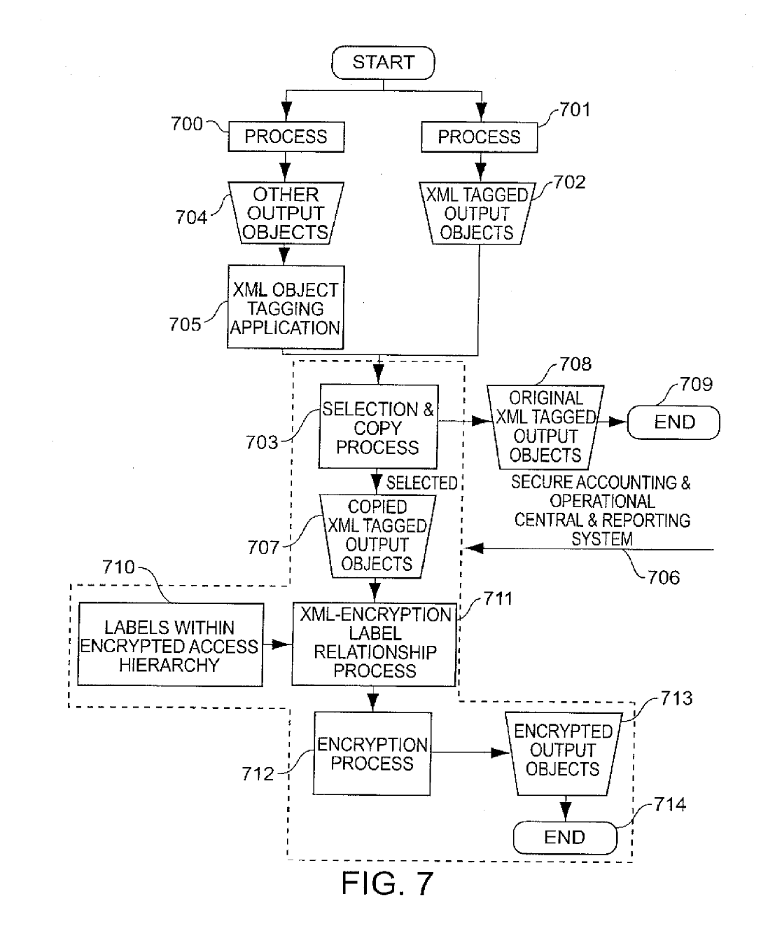

FIG. 7 is a flow diagram showing use of XML to identify, copy, and encrypt copied output objects in a SAOCRS. Initially, output objects 704 of a process 700, 701 might or might not be related to XML tags; if so, the XML-tagged output objects 702 are provided directly to the selection and copy process 703. If required, an XML object-tagging application 705 applies appropriate XML tags to output objects 704. The SAOCRS 706, using XML tags to identify object attributes, selects certain objects 707 according to control requirements and causes identical copies to be made. Original tagged output objects 708 are allowed to pass to their intended processes 709.

Within the SAOCRS 706, the XML tags of each copy of selected output objects 707 are related 711 to labels within the encrypted access hierarchy 710 to determine the appropriate role-based label or labels to be used to encrypt 712 each object. Each output object copy is encrypted 713 and passed to or stored 714 for appropriate persons, devices, or other systems, including other SAOCRSs.

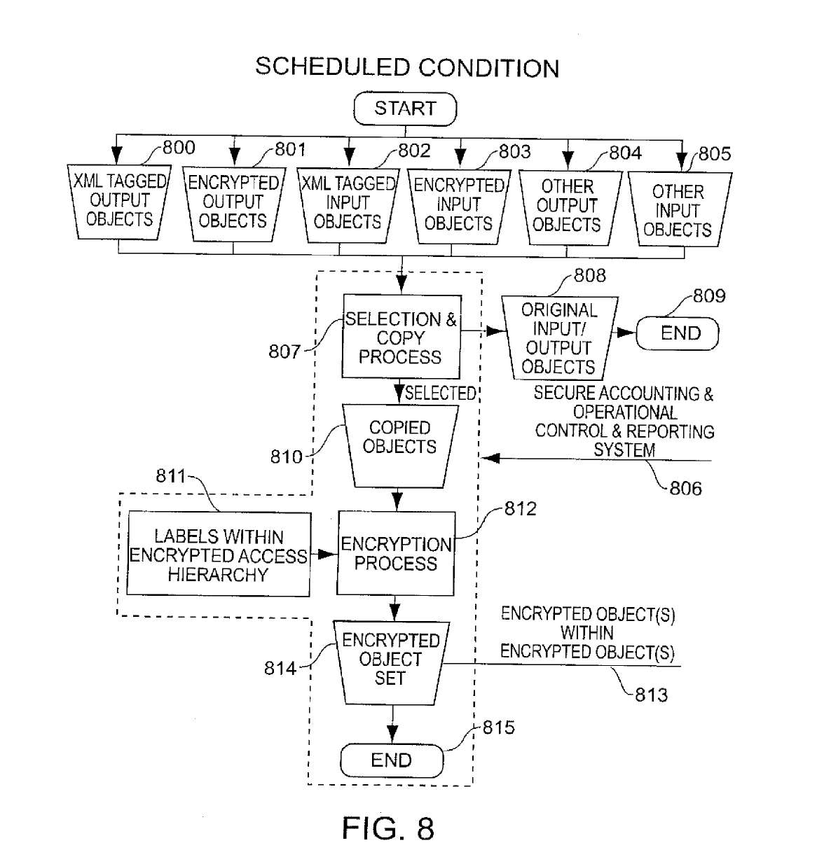

FIG. 8 is a flow diagram showing use of XML to identify, copy, and encrypt copied objects in a SAOCRS that in their entirety present a scheduled condition check. The SAOCRS, from time to time as required, selects input and output objects 800-805 that, when considered in their entirety, fairly represent the condition of a system and in turn assist in affirming the veracity of objects that form the basis for operational or audit activity.

Selected objects 800-805 might or might not have related XML tags that assist in object selection. They each can be either an input or an output of one of multiple separate processes. They can be encrypted input and output objects from other SAOCRSs.

The SAOCRS 806, where possible using XML tags to identify objects attributes, selects certain objects according to control requirements and causes identical copies to be made 807. Original objects 808 are allowed to pass to their intended processes 809.

Within the SAOCRS 806, the XML tags of each copy 810 of a selected object are related to labels 811 within the encrypted access hierarchy to determine the appropriate role-based label or labels to be used to encrypt 812 each object 810. Each selected object 810 without XML tags is related to labels 811 within the encrypted access hierarchy to determine the appropriate role-based label or labels to be used to encrypt 812 each object. Based on the labels 811 used to encrypt 812 each set of objects 810, the SAOCRS 806 determines the appropriate label or labels 811 to be used to encrypt 814 all objects within one overall object 813. This inclusive encrypted object 814, containing encrypted objects verifying the system condition, is then passed to or stored 815 for appropriate persons, devices, or other systems, including other SAOCRSs.

Although the embodiment described above is related to XML data, the present invention is applicable to any type of tagged data, or similarly formatted data. Thus, the present invention can be applied to any type of data that can be tagged via one or more tags (or labels) that describe or identify the data.

According to one exemplary aspect, the present invention can be embodied in a text-formatting language designed to transform raw text (that is, data having at least one target data object) into structured documents, by inserting procedural and/or descriptive markup within the raw text. In another exemplary aspect, a language can be designed to describe or transform, in space or time, data, text, or objects into structured data, text, or objects, such as, for example and not in limitation, a Standard Generalized Markup Language (“SGML”), a Hypertext Markup Language (“HTML”), a Virtual Reality Markup Language (“VRML”), or any other markup or formatting language, including but not limited to those generally and specifically described herein.

By these definitions, a text-formatting language can be designed to transform raw text into structured documents by inserting descriptive markup into the text, much like what is effectuated with Constructive Key Management or other key management and encryption schemes, which can transform objects into structured data.

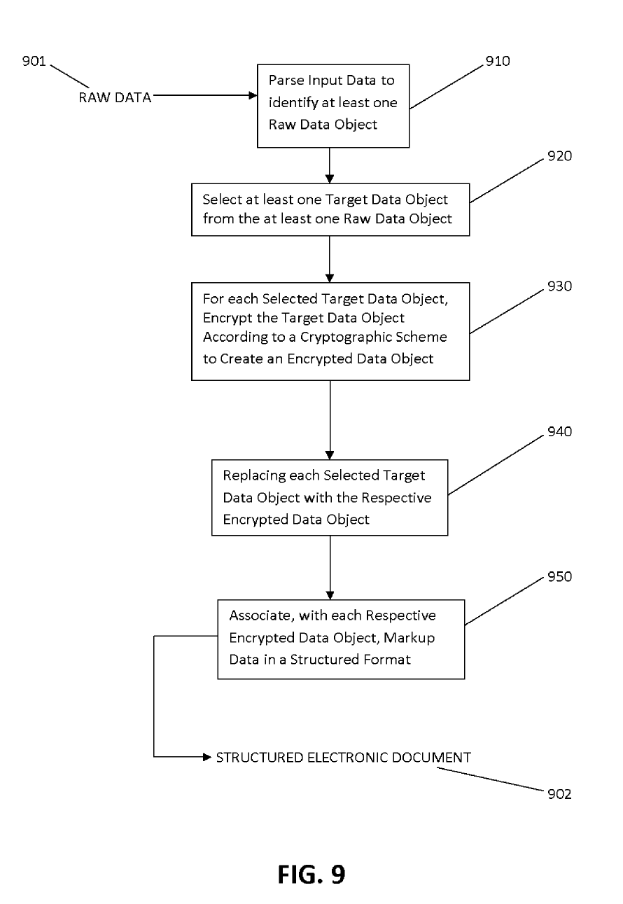

As illustrated in FIG. 9, an exemplary method of converting raw data 901 into a structured electronic document 902 can include parsing 910 the raw data to identify at least one data object. At least one target data object is selected 920 from the at least one raw data object. For each selected target data object, the target data object is encrypted 930 according to a cryptographic scheme to create an encrypted data object. Each selected target data object is replaced 940 with the respective encrypted data object. With each respective encrypted data object, markup data is associated 950 in a structured format, resulting in the structured electronic document. The format of the structured electronic document complies with a formatting language.

In another example, an SGML can be an ISO-standard technology for defining generalized markup languages for documents, and of which XML can be a derivative. The encryption scheme described above can be applied to SGML files and to any SGML-derived schemes known or undeveloped at this time. The tag-based encryption described above can be advantageously applied to SGML data, as SGML is a scheme that generalizes and supports a wide range of markup languages. Because SGML provides an abstract syntax that can be implemented in many different types of concrete syntax, the encryption scheme can be applied to SGML data and any derivatives of SGML, regardless of syntax. Further, particular types of tags need not be identified, and any string of delimiters within an SGML syntax can be used for purposes of applying the described encryption scheme. Notably, SGML (ISO 8879:1986 SGML) is an ISO-standard technology for defining generalized markup languages for documents. ISO 8879 Annex A.1 defines generalized markup as being based on two novel postulates:
Markup should describe a document's structure and other attributes, rather than specify the processing to be performed on it, as descriptive markup needs be done only once, and will suffice for future processing.
Markup should be rigorous so that the techniques available for processing rigorously-defined objects like programs and databases, can be used for processing documents as well.

Further, partial derivatives of SGML, such as an HTML, can also format data in a manner that is suitable for application of the encryption scheme of the present invention. While a plurality of HTML versions are in use, notably, all use tags or other delimiters that can be used to encrypt the tagged data according to the scheme of the present invention.

Another example of a formatting language to which the present invention can be applied is data presented in an eXtensible Business Reporting Language (“XBRL”), which is one of a family of XML-based languages that is becoming a standard means of communicating information between businesses over the Internet.

In another exemplary aspect, the present invention can be applied to any type of formatting language that utilizes data tagging that is functionally compatible with the present invention. Therefore, in addition to SGML, HTML, and XBRL, which are discussed above, the present invention can similarly be applied to any existing, or future-developed, formatting language that utilizes data tagging in a manner that is functionally compatible with the present invention.

According to a further exemplary aspect, the present invention can be applied to any general-purpose or specific-purpose formatting language, such as markup languages. A general-purpose formatting language can be intended for utilization across a plurality of industries, environments, and/or applications, whereas a specific-purpose formatting language can be intended for one or more specific, or classes of, industries, environments, and/or applications.

### General-Purpose Formatting Languages

Exemplary general-purpose formatting languages can include, in addition to an XML, an SGML, and an HTML, a Dynamic HyperText Markup Language (“DHTML”), an Extensible Hypertext Markup Language (“XHTML”), and a Serialization of a Resource Description Framework (RDF), for example.

According to a further exemplary aspect, the present invention can be applied to a DHTML, which can include a plurality of technologies to collectively provide an interactive and/or animated network or Web site, whether over an intranet or the Internet. For example, a DHTML can generally utilize one or more of the following technologies: a static markup language (such as HTML, for example), a client-side scripting language (such as JavaScript, C, and Jscript, for example), a presentation definition language (such as Cascading Style Sheets, for example), and a Document Object Model. Notably, the present invention can be applied to one or more of these technologies independently or in the context of a DHTML.

In another exemplary aspect, the present invention can be applied to an XHTML, which can be an HTML defined as an XML application. Although an XHTML can be similar to particular instances of HTML, such as HTML 4.01, it can also be considered a stricter, cleaner version of HTML, or simply as an HTML defined as an XML application.

According to another exemplary aspect, the present invention can be applied to a Serialization of a Resource Description Framework (“RDF”), which can be an RDF/XML or an RDF/Notation3 (“N3”).

RDF can be considered a standard model for data interchange over a network, such as the Internet or an intranet for example, as it can facilitate data merging across different schemas, which promotes schema evolution without requiring changes by data consumers, RDF utilizes Uniform Resource Identifiers (URIs) to extend the linking structure of a network by defining “triples,” which include both ends (that is, an origination and destination network resource) of a link as well as a relationship between them. This extended linking structure promotes structured and/or semi-structured data to be merged, and thereafter shared between applications. As such, this extended linking structure can be represented as a directed, labeled graph where nodes represent resources and edges represent named links between resources.

RDF/XML is a particular syntax defined by the World Wide Web Consortium (W3C) to serialize, or express, an RDF graph as an XML document. As such, the present invention can advantageously apply to an RDF/XML syntax.

As a shorthand, non-XML serialization of RDF models, N3 can be more compact than RDF/XML notation. However, it also provides tagging in a manner that is functionally compatible with the present invention. For example, the following is an exemplary N3 format:

@prefix dc: <http://purl.org/dc/elements/1.1/>.
<http://en.wikipedia.org/wiki/Dustin_Pedroia>

dc:title “Dustin Pedroia”;
dc:publisher “Wikipedia”.

In this example, the tag “dc:title” can be viewed as describing the data object “Dustin Pedroia” in accordance with the present invention. Notably, Turtle, as a simplified, RDF-only subset of N3, provides tagged data in the same manner as the example above, and therefore, can also benefit from the utility of present invention.

### Specific-Purpose Formatting Languages

As described above, a specific-purpose formatting language can be intended for one or more specific, or classes of, industry, environment, and/or application. For example, formatting languages can be devised for specific use with financial industries, documents, for use in a specific business, for military and/or law enforcement applications, in human manifestations and/or perceptions applications, for use in particular media or with media standards, in the aerospace industry, and for research applications.

### Financial Industries

According to an exemplary aspect, the present invention can be applied to a financial industry, which can include the over-the-counter (otc) derivatives industry, for example. The financial industry covers a plurality of financial products, which can include tangible and/or intangible goods and/or services relating to financial investments. Accordingly, exemplary products can include financial planning and/or investment securities, such as stocks, bonds, and/or funds, for example.

An exemplary formatting language utilized in the financial industry can be a Financial products Markup Language (FpML), which is an XML message standard for the OTC derivatives industry. The scope of FpML can include, but is not limited to, one or more of the following products: Foreign exchange (FX) swaps and/or options, interest rate swaps, inflation swaps, asset swaps, swaptions, credit default swaps, credit default swap indices, credit default swap baskets, tranches on credit default swap indices, equity options, equity swaps, and total return swaps. Particular FpML processes can include, but are not limited to, trading, valuation, confirmation, novations, increases, amendments, terminations, allocations, position reporting, cash flow matching, a formal definition of a party role, and trade notification between asset managers and/or custodians.

### Documents

According to another exemplary aspect, the present invention can be applied to documents, including but not limited to, the preparation, typesetting, representation, delivery, receipt, and manipulation of documents. An exemplary formatting language to which the present invention can be applied is LaTeX, for example, which is a document markup language and document preparation system for the TeX typesetting program.

### Business

According to another exemplary aspect, the present invention can be applied to business-oriented data, which can include any type of data that involves or can be utilized in a business environment, including communications, finances, documents, logistics, processes, inventory, analyses, statements, and reports, for example.

Exemplary business-oriented formatting languages can include, but are not limited to, an XBRL, a Business Narrative Markup Language (BNML), a Business Process Modeling Language (BPML), and an eXtensible Business Reporting Language (XBRL).

A BNML can be a general-purpose XML schema utilizable to format a numerous types of business-related data, including technical, business, and legal data, for example. A BPML can be a meta-language utilizable to model business processes (cf. XML as a meta-language for the modeling of business data). An XBRL, which is based on XML, can be utilized to facilitate the exchange of business data. An XBRL can employ XML syntax and/or aspects, including but not limited to, an XML Schema, XLink, Xpath, and Namespaces, and further, can define and/or facilitate the exchange of business-related data. An implemented XBRL, via a formal specification, was developed and published by XBRL International, Inc.

Military and/or Law Enforcement

According to another exemplary aspect, the present invention can be applied to a formatting language involving military- and/or law enforcement-related data and/or applications, which can include operations, equipment, logistics, training, intelligence, and/or investigations. Further, such data and/or applications can be based on actual or virtual data and/or environments, and notably, can involve simulations, including gaming environments, for example.

For example, the present invention can be applied to BulletML, which is an open source program that provides the replication of bullet patterns.

Human Manifestations and/or Perceptions

According to another exemplary aspect, the present invention can be applied to a formatting language involving actual and/or virtual human manifestations and/or perceptions.

According to an exemplary aspect, the present invention can be applied to an Emotion Markup Language (“EML”), which can accommodate various aspects of interactions between one or more humans and one or more computers. Exemplary interactions can involve facial and/or body animation; dialogue management, including dialogue interaction; text-to-speech data, including production; and emotion representation, including uni-, hyper-, and multi-media data.

According to another exemplary aspect, the present invention can be applied to a Virtual Reality Modeling Language (“VRML”), which can represent 3-dimensional (3D) interactive vector graphics, and can be designed for applications over networks, such as the Internet, for example. More particularly, a VRML can represent one or more of the following: vertices and edges for a 3D object (such as a polygon, for example), surface colors, surface textures, UV mapped textures (UV mapping is the 3D modeling process of making a 2D image representation of a 3D model), shininess, transparency, and any other visual characteristics of visually represented objects. Further, a Uniform Resource Locator (“URL”) can be associated with one or more graphical components such that a user selection (such as a user click, for example) can effectuate a data request from another network resource, such as a Webpage or another VRML file, for example. Moreover, one or more of animations, sounds, lighting, physical effects, and other aspects of a virtual environment can be interactive with a user and/or triggered by external events, such as timers or any other logical event, for example. Additionally, a Script Node can allow the addition of script (for example, Java, JavaScript, or ECMAScript) to a VRML file for increased functionality. VRML files, commonly called “worlds,” can be represented in text format, and are often compressed (such as with GZIP, for example) to reduce network transfer times. Notably, VRML has been superseded by X3D.

According to an exemplary aspect, the present invention can be applied to a Virtual Human Markup Language (“VHML”). A VHML can facilitate the natural and realistic interaction of a virtual person (for example, a “talking head” or “talking person”) with a user via an interface and/or application. Exemplary interactive aspects can include facial expressions, body gestures, and voice tone, speed, inflection, cadence, and rhythm, which can be illustratively found in deliverables of the Interface Project at http://interface.dsp.dist.unige.it/.

A VHML can use and/or build on existing standards, such as Sable and an Artificial Intelligence Markup Language (“AIML”) for example, and can describe one or more new languages to accommodate new desired functionality. Further, a VHML can be based on an XML/eXtensible Stylesheet Language (XML/XSL), and can consist of one or more of the following formatting languages and/or technologies: a Dialogue Manager Markup Language (or Dialogue Moves Markup Language; collectively, “DMML”), a Facial Animation Markup Language (“FAML”), a Body Animation Markup Language (“BAML”), a Speech Markup Language (SML); an Emotion Markup Language (“EML”), and a HyperText Markup Language (“HTML”). Notably, the present invention can be selectively applied to one or more of these languages and/or technologies, independently or in the context of a VHML. Further, a VHML can utilize XML Namespaces to inherit existing standards, but notably, is not necessarily limited to pre-existing standards.

According to a further exemplary aspect, the present invention can be applied to a VoiceXML, which can be effectuated via an XML format to specify interactive voice dialogue between one or more humans and/or one or more computers. Exemplary applications of a VoiceXML can include deployment via HTML for visual applications, or via a network, such as an intranet, the Internet, or a Public Switched Telephone Network (“PSTN”), for example.

According to another exemplary aspect, the present invention can be applied to an Extensible Messaging and Presence Protocol (XMPP), which can define one or more network-based messaging protocols, such as messaging between one or more persons and/or one or more computers, for example. Further, an XMPP can extend to text and/or binary message data.

According to a further exemplary aspect, the present invention can be applied to an Ink Markup Language (“InkML”), which can provide a data format that represents “ink” entered by a user with a stylus, electronic pen, finger, fingerprint, or other input device consistent with a writing or ink-transferring instrument. Exemplary aspects of an InkML can cover input and/or processing of such “ink,” including handwriting, gestures, sketches, music, stamped images, and/or any other notational language. Further, exemplary applications can include handwriting and/or gesture recognition, signature verification, and any other ink-based processing applications. Notably, an InkML can also be used in the W3C Multimodal Interaction Framework as proposed by the W3C Multimodal Interaction Activity.

### Media

According to another exemplary aspect, the present invention can be applied to formatting languages involving media data, including content and/or functional, structural, and/or formatting aspects of media data. Exemplary applications include a graphical user interface (“GUI”), a Website, a widget, browser software, and a single medium or multi-media presentation. Further, media data optionally can be compressed. Exemplary formatting languages can include a Synchronized Multimedia Integration Language (“SMIL”), a XML User Interface Language (“XUL”), a Meta Content Framework (“MCF”), an Augmenting Script Language (“ASL”), a Browser Binary Markup Language (“BBML”), an eXtensible Bindings Language (“XBL”), and an XML Bookmark Exchange Language (“XBEL”).

According to an exemplary aspect, the present invention can be applied to a SMIL, which can describe a single and/or multi-media presentation. For example, exemplary descriptions can include data representing content, timing, layout, animations, visual and/or audio transitions, and media embedding. Further, exemplary content can include text, binary data, images, video, audio, links to additional content, including additional SMIL presentations and/or files from one or more external sources, such as a network server or memory, for example.

According to a further exemplary aspect, the present invention can be applied to an XML User Interface Language (“XUL”), such as the XML User Interface Markup Language developed by the Mozilla Project. This implementation of XUL can operate in Mozilla cross-platform applications, such as FIREFOX and FLOCK.

In another exemplary aspect, the present invention can be applied to a Meta Content Framework (“MCF”), which can provide a format for the structuring and/or functionality of metadata regarding network resources (such as Websites, for example) and/or other data to the extent desired. An exemplary application of MCF can include the generation of a 3-dimensional representation of a Website's table of contents based on MCF descriptions, as was effectuated by HOTSAUCE, which was developed by Ramanathan Guha.

According to a further exemplary aspect, the present invention can be applied to an Augmenting Script Language (“ASL”), which can augment a markup language with database commands, conditional operators, formatting functions, and/or other functions, for example, to produce applications, such as network applications, for example. An exemplary ASL can be a ColdFusion Markup Language (“CFML”), which is a scripting language utilizable with ADOBE COLDFUSION, BLUE DRAGON, RAILO, and other CFML server engines.

According to another exemplary aspect, the present invention can be applied to a Browser Binary Markup Language (“BBML”) that can be utilized to increase the overall speed and/or usability of a data provisioning from a network resource to an application, such as a Web browser for example. An overall speed increase and/or usability improvement can be realized through data compression and/or data reformatting effectuated via BBML formatted data. An exemplary BBML is an Opera Binary Markup Language (“OBML”) that can be utilized with the Web browser, OPERA MINI, which is designed to extract server content through a proxy that reformats and/or compresses the content into OBML formatted data.

According to yet another exemplary aspect, the present invention can be applied to an eXtensible Bindings Language (“XBL”), which is an XML-based formatting language that can describe the behavior and/or visual appearance of widgets (such as XUL-Widgets, for example) and/or XML elements. An exemplary XBL was developed by the Mozilla Project for use with the Mozilla application suite. Though this particular implementation of XBL is proprietary to Mozilla, a newer version, XBL 2.0, is currently undergoing standardization by the World Wide Web Consortium.

According to a further exemplary aspect, the present invention can be applied to an XML Book Exchange Language (“XBEL”), which is a network address interchange format that facilitates the exchanging of network addresses, such as Internet bookmarks, for example. An exemplary XBEL, an idea of Mark Hammond, was developed for use with PYTHON XML processing software, and described bookmark data for a plurality of browser applications.

### Aerospace

According to another exemplary aspect, the present invention can be applied to the aerospace industry and/or aerospace applications. Exemplary formatting languages can include an Aerospace Markup Language (“AML”) and a Parameter Value Language (“PVL”).

An exemplary AML is the Spacecraft Markup Language (“SML,” cf. Speech Markup Language), which is an extension of XML that provides standard definitions of XML tags and structural components relating to spacecraft and support data. Exemplary data described and contained within SML formatted data can include commands, telemetry, abstract messages, and scientific data. Further, an SML-defined database can include one or more of the following: commands, telemetry data and/or packets, application messages, events, scientific data, and status information, such as for logging purposes for example. Further, an SML can facilitate a protocol stack approach to processing data objects due to its well-defined structure and scope, which in turn provides an object-oriented method of describing a database structure.

According to another exemplary aspect, the present invention can be applied to a Parameter Value Language (“PVL”), which is a formatting language employed for entries in the Planetary Database System utilized by NASA to store aerospace data, including mission data, for example.

### Research

According to another exemplary aspect, the present invention can be applied to formatting languages relating to research. Exemplary data can include data objects, data attributes, statistics, computational models and/or methods, logical relationships between data objects, and scientific phenomena.

An exemplary formatting language can be a Systems Biology Markup Language (“SBML”), which is a representation format based on XML. An SBML can facilitate the storage and/or communication of computational models and/or methods of biological processes, as well as biological-related data. Further, an SBML can represent numerous, differing classes of biological phenomena, including metabolic networks, cell-signaling pathways, regulatory networks, and infectious diseases.

It will be apparent to one of ordinary skill in the art that the manner of making and using the claimed invention has been adequately disclosed in the above-written description of the exemplary embodiments and aspects taken together with the drawings.

It should be understood, however, that the invention is not necessarily limited to the specific embodiments, aspects, arrangement, and components shown and described above, but can be amenable to numerous variations within the scope of the invention, and the same are intended to be comprehended within the meaning and range of equivalents of the appended claims.

Accordingly, the specification and drawings are to be regarded in an illustrative and enabling, rather than a restrictive, sense.

What is claimed is:

1. A method of cryptographically converting raw data into a structured electronic document, comprising:
parsing the raw data to identify at least one raw data object;
selecting at least one target data object from the at least one raw data object;
for each said selected target data object, encrypting the target data object according to a cryptographic scheme to create an encrypted data object; and
replacing each said selected target data object with the respective encrypted data object, and associating for each respective encrypted data object, markup data in a structured format, resulting in the structured electronic document;
wherein the format of the structured electronic document complies with a formatting language.

2. The method of claim 1, wherein the format of the structured electronic document complies with a Hypertext Markup Language and a scripting language.

3. The method of claim 2, wherein the scripting language is one of Javascript, Jscript, ECMAScript, and C.

4. The method of claim 3, wherein the format of the structured electronic document further complies with a Document Object Model.

5. The method of claim 4, wherein the format of the structured electronic document further complies with a Cascading Style Sheet.

6. The method of claim 1, wherein the formatting language is a general-purpose markup language.

7. The method of claim 1, wherein the formatting language is a specific-purpose markup language.

8. The method of claim 1, wherein the formatting language is adapted for a use relating to one or more of a financial industry, documents, business, military and law enforcement, at least one of a human manifestation and a human perception, media, aerospace, and research.

9. The method of claim 1, wherein the markup data describes, at least in part, a structure of the electronic document.

10. The method of claim 1, wherein the markup data describes, at least in part, an attribute of at least one encrypted data object.

11. The method of claim 1, wherein the markup data includes at least one tag.

12. The method of claim 1, wherein the raw data includes virtual data.

13. The method of claim 1, wherein the raw data includes actual data.

14. The method of claim 1, wherein the one or more selected target objects includes one or more of a database command, a conditional operator, a function, and a network application production element.

15. The method of claim 1, wherein the one or more selected target objects represents, at least in part, an electronic ink image.

16. The method of claim 1, wherein the one or more selected target objects represents, at least in part, metadata.

17. The method of claim 1, wherein the one or more selected target objects includes compressed Web page data.

18. The method of claim 1, wherein the one or more selected target objects represents, at least in part, an entry in a Planetary Database System.

19. The method of claim 1, wherein the one or more selected target objects represents, at least in part, a Uniform Resource Identifier.
